(19) United States
(12) Patent Application Publication
(10) Pub. No.: US 2007/0099939 A1
(43) Pub. Date: May 3, 2007

(54) Fungicidal mixtures for controlling rice pathogens

(76) Inventors: Jordi Tormo i Blasco, Laudenbach (DE); Thomas Grote, Wachenheim (DE); Maria Scherer, Godramstein (DE); Reinhard Stierl, Freinsheim (DE); Siegfried Strathmann, Limburgerhof (DE); Ulrich Schofl, Bruhl (DE)

Correspondence Address: BIRCH STEWART KOLASCH & BIRCH, PO BOX 747, FALLS CHURCH, VA, 22040-0747, US

(21) Appl. No.: 10/576,203

(22) PCT Filed: Oct. 27, 2004
(86) PCT No.: PCT/EP04/12116

§ 371 Date: Apr. 17, 2006

(30) Foreign Application Priority Data
Oct. 29, 2003 (DE) 103 50 813.9

(51) Int. Cl. A01N 43/90; A01N 43/32

(52) U.S. Cl. 514/259.31; 514/433

(57) ABSTRACT

Fungicidal mixtures for controlling rice pathogens, which mixtures comprise, as active components,
1) the triazolopyrimidine derivative of the formula I, 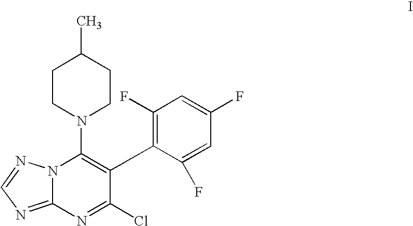 and
2) carboxin of the formula II, 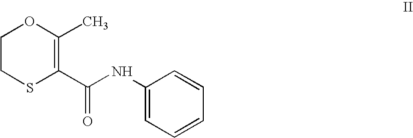 in a synergistically effective amount, methods for controlling rice pathogens using mixtures of the compound I with the compound II, the use of the compound I with the compound II for preparing such mixtures and compositions comprising these mixtures are described.

The present invention relates to fungicidal mixtures for controlling rice pathogens, which mixtures comprise, as active components,
1) the triazolopyrimidine derivative of the formula I, 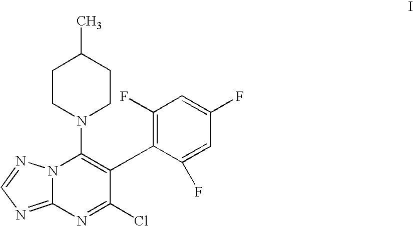
and
2) carboxin of the formula II, 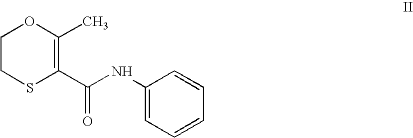
in a synergistically effective amount.

Moreover, the invention relates to a method for controlling rice pathogens using mixtures of the compound I with the compound II and to the use of the compound I with the compound II for preparing such mixtures and compositions comprising these mixtures.

The compound I, 5-chloro-7-(4-methylpiperidin-1-yl)-6-(2,4,6-trifluorophenyl)-[1,2,4]triazolo[1,5-a]pyrimidine, its preparation and its action against harmful fungi are known from the literature (WO 98/46607).

The compound II, N-phenyl-2-methyl-5,6-dihydro-[1,4]oxathiine-3-carboxamide, its preparation and its action against harmful fungi are likewise known from the literature (U.S. Pat. No. 3,454,391; common name: carboxin). It is commercially established as a seed dressing.

Mixtures of triazolopyrimidine derivatives with carboxin are known in a general manner from EP-A 988 790. The compound I is embraced by the general disclosure of this publication, but not explicitly mentioned. Accordingly, the combination of compound I with carboxin is novel.

The synergistic mixtures known from EP-A 988 790 are described as being fungicidally active against various diseases of cereals, fruit and vegetables, for example mildew on wheat and barley or gray mold on apples.

Owing to the special cultivation conditions of rice plants, the requirements that a rice fungicide has to meet are considerably different from those that fungicides used in cereal or fruit growing have to meet. There are differences in the application method: in modern rice cultivation, in addition to foliar application, which is usual in many places, the fungicide is applied directly onto the soil during or shortly after sowing. The fungicide is taken up into the plant via the roots and transported in the sap of the plant to the plant parts to be protected. In contrast, in cereal or fruit growing, the fungicide is usually applied onto the leaves or the fruits; accordingly, in these crops the systemic action of the active compounds is considerably less important.

Moreover, rice pathogens are typically different from those in cereals or fruit. Pyricularia oryzae, Cochliobolus miyabeanus and Corticium sasakii (syn. Rhizoctonia solani) are the pathogens of the diseases most prevalent in rice plants. Rhizoctonia solani is the only pathogen of agricultural significance from the sub-class Agaricomycetidae. In contrast to most other fungi, this fungus attacks the plant not via spores but via a mycelium infection.

For this reason, findings concerning the fungicidal activity in the cultivation of cereals or fruit cannot be transferred to rice crops.

Practical agricultural experience has shown that the repeated and exclusive application of an individual active compound in the control of harmful fungi leads in many cases to a rapid selection of such fungus strains which have developed natural or adapted resistance against the active compound in question. Effective control of these fungi with the active compound in question is then no longer possible.

To reduce the risk of selection of resistant fungus strains, mixtures of different active compounds are nowadays usually employed for controlling harmful fungi. By combining active compounds having different mechanisms of action, it is possible to ensure successful control over a relatively long period of time.

It was an object of the present invention to provide, with a view to effective resistance management and effective control of rice pathogens at application rates which are as low as possible, mixtures which, at a total amount of active compounds applied which is reduced, have an improved effect against the harmful fungi.

We have found that this object is achieved by the mixtures defined at the outset. Moreover, we have found that simultaneous, that is joint or separate, application of the compounds I and II or successive application of the compounds I and II allows better control of rice pathogens than is possible with the individual active compounds.

When preparing the mixtures, it is preferred to employ the pure active compounds I and II, to which further active compounds against harmful fungi or other pests, such as insects, arachnids or nematodes, or else herbicidal or growth-regulating active compounds or fertilizers can be added as required.

Other suitable active compounds in the above sense are in particular fungicides selected from the following group:
acylalanines, such as benalaxyl, ofurace, oxadixyl,
amine derivatives, such as aldimorph, dodemorph, fenpropidin, guazatine, iminoctadine, tridemorph,
antibiotics, such as cycloheximid, griseofulvin, kasugamycin, natamycin, polyoxin or streptomycin,
azoles, such as bitertanol, bromoconazole, cyproconazole, difenoconazole, dinitroconazole, enilconazole, fenbuconazole, fluquinconazole, flusilazole, flutriafol, hexaconazole, imazalil, ipconazole, myclobutanil, penconazole, propiconazole, prochloraz, prothioconazole, simeconazole, tetraconazole, triadimefon, triadimenol, triflumizole, triticonazole,
dicarboximides, such as myclozolin, procymidone,
dithiocarbamates, such as ferbam, nabam, metam, propineb, polycarbamate, ziram, zineb,
heterocyclic compounds, such as anilazine, boscalid, carbendazim, oxycarboxin, cyazofamid, dazomet, famoxadon, fenamidon, fuberidazole, flutolanil, furametpyr, isoprothiolan, mepronil, nuarimol, probenazole, pyroquilon, silthiofam, thiabendazole, thifluzamid, tiadinil, tricyclazole, triforine,
nitrophenyl derivatives, such as binapacryl, dinocap, dinobuton, nitrophthalisopropyl,
phenylpyrroles, such as fenpiclonil or fludioxonil,
other fungicides, such as acibenzolar-S-methyl, carpropamid, chlorothalonil, cyflufenamid, cymoxanil, diclomezin, diclocymet, diethofencarb, edifenphos, ethaboxam, fentin acetate, fenoxanil, ferimzone, fosetyl, hexachlorobenzene, metrafenone, pencycuron, propamocarb, phthalide, toloclofos-methyl, quintozene, zoxamide,
strobilurins, such as fluoxastrobin, metominostrobin, orysastrobin or pyraclostrobin,
sulfenic acid derivatives, such as captafol,
cinnamides and analogous compounds, such as flumetover.

In one embodiment of the mixtures according to the invention, a further fungicide III or two fungicides III and IV are added to the compounds I and II. Preference is given to mixtures of the compounds I and II with a component III. Particular preference is given to mixtures of the compounds I and II.

The mixtures of compounds I and II, or the compounds I and II used simultaneously, that is jointly or separately, exhibit outstanding action against rice pathogens from the classes of the Ascomycetes, Deuteromycetes and Basidiomycetes. They can be used for the treatment of seed and as foliar- and soil-acting fungicides.

They are especially important for controlling harmful fungi on rice plants and their seeds, such as Bipolaris and Drechslera species, and also Pyricularia oryzae. They are particularly suitable for controlling brown spot of rice, caused by Cochliobolus miyabeanus.

In addition, the combination according to the invention of the compounds I and II can also be used for controlling other pathogens, such as, for example, Septoria and Puccinia species in cereals and Alternaria and Botrytis species in vegetables, fruit and grapevines.

The compound I and the compound II can be applied simultaneously, that is jointly or separately, or in succession, the sequence, in the case of separate application, generally not having any effect on the result of the control measures.

The compound I and the compound II are usually applied in a weight ratio of from 100:1 to 1:100, preferably from 20:1 to 1:50, in particular from 2:1 to 1:20.

The components III and, if appropriate, IV are, if desired, added to the compound I in a ratio of from 20:1 to 1:20.

Depending on the type of compound and on the desired effect, the application rates of the mixtures according to the invention are from 5 g/ha to 2 kg/ha.

Correspondingly, the application rates of the compound I are generally from 1 to 1000 g/ha, preferably from 10 to 750 g/ha, in particular from 20 to 500 g/ha.

Correspondingly, the application rates of the compound II are generally from 1 to 2000 g/ha, preferably from 10 to 1500 g/ha, in particular from 20 to 1000 g/ha.

In the treatment of seed, the application rates of mixture are generally from 1 to 1000 g/100 kg of seed, preferably from 1 to 750 g/100 kg, in particular from 5 to 500 g/100 kg.

In the control of harmful fungi pathogenic to rice plants, the separate or joint application of the compounds I and II or of the mixtures of the compounds I and II is carried out by spraying or dusting the seeds, the seedlings, the plants or the soils before or after sowing of the plants or before or after emergence of the plants. The compounds I and II are preferably applied by spraying the leaves. The application of the compounds can also be carried out by applying granules or by dusting the soils.

The mixtures according to the invention or the compounds I and II can be converted into the customary formulations, for example solutions, emulsions, suspensions, dusts, powders, pastes and granules. The application form depends on the particular purpose; in each case, it should ensure a fine and uniform distribution of the compound according to the invention.

The formulations are prepared in a known manner, for example by extending the active compound with solvents and/or carriers, if desired using emulsifiers and dispersants. Solvents/auxiliaries which are suitable are essentially:
water, aromatic solvents (for example Solvesso products, xylene), paraffins (for example mineral oil fractions), alcohols (for example methanol, butanol, pentanol, benzyl alcohol), ketones (for example cyclohexanone, gammabutyrolactone), pyrrolidones (NMP, NOP), acetates (glycol diacetate), glycols, fatty acid dimethylamides, fatty acids and fatty acid esters. In principle, solvent mixtures may also be used.
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignosulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations: 1. Products for dilution with water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifying machine (Ultraturrax) and made into a homogeneous emulsion. Dilution with water gives an emulsion.

E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersants, wetters and silica gel. Dilution with water gives a stable dispersion or solution of the active compound.

2. Products to be Applied Undiluted

H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and associated with 95.5% carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, if appropriate just immediately prior to use (tank mix). These agents are typically admixed with the compositions according to the invention in a weight ratio of 1:10 to 10:1.

The compounds I and II or the mixtures or the corresponding formulations are applied by treating the harmful fungi or the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal action of the compound and the mixtures can be demonstrated by the experiments below:

The active compounds, separately or jointly, were prepared as a stock solution with 0.25% by weight of active compound in acetone or DMSO. 1% by weight of the emulsifier Uniperol® EL (wetting agent having emulsifying and dispersing action based on ethoxylated alkylphenols) was added to this solution, and the solution was diluted with water to the desired concentration.

Use Example—Activity Against Brown Spot of Rice Caused by Cochliobolus Miyabeanus, Protective Application

Leaves of potted rice seedlings of the cultivar “Tai-Nong 67” were sprayed to runoff point with an aqueous suspension of the concentration of active compound stated below. The next day, the plants were inoculated with an aqueous spore suspension of Cochliobolus miyabeanus. The test plants were then placed in climatized chambers at 22-24° C. and 95-99% relative atmospheric humidity for six days. The extent of the development of the infection on the leaves was then determined visually.

Evaluation was carried out by determining the percentage of infected plants. These percentages were converted into efficacies.

The efficacy (E) is calculated as follows using Abbot's formula:
E=(1−α/β)·100
α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants are not infected.

The expected efficacies of mixtures of active compounds are determined using Colby's formula (R.S. Colby, Weeds, 15, 20-22, 1967) and compared with the observed efficacies.

Colby's Formula:
E=x+y−x·y/100
E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b

The comparative compounds used were compounds A and B known from the carboxin mixtures described in EP-A 988 790:

TABLE A

| | |
|---|---|
| | A |
| 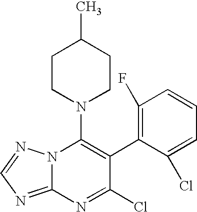 | |
| | B |
| 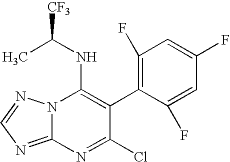 | |

individual active compounds

| | | Concentration of | |
|---|---|---|---|
| | | active compound | Efficacy in % |
| Ex- | | in the spray | of the untreated |
| ample | Active compound | liquor [ppm] | control |
| 1 | control (untreated) | — | (90% infection) |
| 2 | I | 4 | 33 |
| 3 | II (carboxin) | 4 | 0 |
| | | 1 | 0 |
| 4 | comparative | 4 | 44 |
| | compound A | | |
| 5 | comparative | 4 | 44 |
| | compound B | | |

TABLE B
mixtures according to the invention

| | Mixture of active compounds | | |
|---|---|---|---|
| Ex- | Concentration | Observed | Calculated |
| ample | Mixing ratio | efficacy | efficacy*) |
| 6 | I + II | 89 | 33 |
| | 4 + 1 ppm | | |
| | 4:1 | | |
| 7 | I + II | 94 | 33 |
| | 4 + 4 ppm | | |
| | 1:1 | | |

*)efficacy calculated using Colby's formula

TABLE C
comparative tests

| | Mixture of active compounds | | |
|---|---|---|---|
| Ex- | Concentration | Observed | Calculated |
| ample | Mixing ratio | efficacy | efficacy*) |
| 8 | A + II | 67 | 44 |
| | 4 + 1 ppm | | |
| | 4:1 | | |
| 9 | A + II | 67 | 44 |
| | 4 + 4 ppm | | |
| | 1:1 | | |
| 10 | B + II | 56 | 44 |
| | 4 + 1 ppm | | |
| | 4:1 | | |
| 11 | B + II | 56 | 44 |
| | 4 + 4 ppm | | |
| | 1:1 | | |

*)efficacy calculated using Colby's formula

The test results show that the mixtures according to the invention, owing to strong synergism, are considerably more effective than the carboxin mixtures, known from EP-A 988 790, although the comparative compounds, as individual active compounds, at the same application rates, are more effective than compound I.

1. A fungicidal mixture, which mixture comprises
1) triazolopyrimidine derivative of formula I: 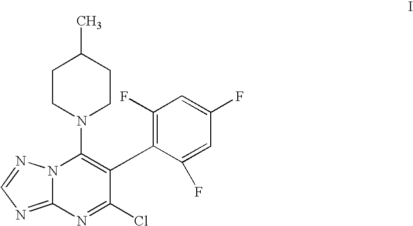
and
2) carboxin of formula II, 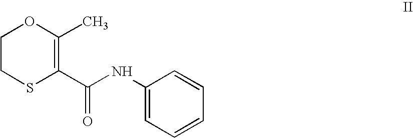
in a synergistically effective amount.

2. The fungicidal mixture as claimed in claim 1 comprising the compound of the formula I and the compound of the formula II in a weight ratio of from 100:1 to 1:100.

3. A fungicidal composition comprising a liquid or solid carrier and the mixture as claimed in claim 1.

4. A method for controlling rice-pathogenic harmful fungi, which comprises treating the fungi, their habitat or the plants, the soil or the seed to be protected against fungal attack with an effective amount of the compound of the formula I and the compound of the formula II as set forth in claim 1.

5. The method according to claim 4, wherein the compounds of the formulas I and II are applied simultaneously, that is jointly or separately, or in succession.

6. The method according to claim 4, wherein the mixture is applied in an amount of from 5 g/ha to 2000 g/ha.

7. The method according to claim 4, wherein the harmful fungus Pyricularia oryzae is controlled.

8. The method according to claim 4, wherein the mixture is applied in an amount of from 1 to 1000 g/100 kg of seed.

9. Seed comprising the mixture as claimed in claim 1 in an amount of from 1 to 1000 g/100 kg.

10. A process for preparing a fungicidal composition comprising:
extending the compound of the formula I and the compound of the formula II as set forth in claim 1 with at least one solvent and/or at least one carrier.

11. A fungicidal composition comprising a liquid or solid carrier and the mixture as claimed in claim 2.

12. A method wherein the compounds of the formulas I and II as set forth in claim 1 are applied simultaneously, that is jointly or separately, or in succession.

13. A method wherein the mixture as claimed in claim 1 is applied in an amount of from 5 g/ha to 2 000 g/ha.

14. A method wherein the mixture as claimed in claim 2 is applied in an amount of from 5 g/ha to 2 000 g/ha.

15. The method according to claim 5, wherein the harmful fungus Pyricularia oryzae is controlled.

16. The method according to claim 6, wherein the harmful fungus Pyricularia oryzae is controlled.

17. The method according to claim 5, wherein the mixture is applied in an amount of from 1 to 1000 g/100 kg of seed.

18. A method wherein the mixture as claimed in claim 1 is applied in an amount of from 1 to 1000 g/100 kg of seed.

19. A method wherein the mixture as claimed in claim 2 is applied in an amount of from 1 to 1000 g/100 kg of seed.

20. Seed comprising the mixture as claimed in claim 2 in an amount of from 1 to 1000 g/100 kg.
